(19) United States
(12) Patent Application Publication
(10) Pub. No.: US 2016/0225393 A1
(43) Pub. Date: Aug. 4, 2016

(54) PERPENDICULAR MAGNETIC RECORDING MEDIUM AND METHOD FOR PRODUCING THE SAME

(71) Applicant: NATIONAL INSTITUTE FOR MATERIALS SCIENCE, Ibaraki (JP)

(72) Inventors: Bollapragada VARAPRASAD, Ibaraki (JP); Yukiko TAKAHASHI, Ibaraki (JP); Kazuhiro HONO, Ibaraki (JP)

(73) Assignee: NATIONAL INSTITUTE FOR MATERIALS SCIENCE, Ibaraki (JP)

(21) Appl. No.: 15/021,285

(22) PCT Filed: Aug. 25, 2014
(86) PCT No.: PCT/JP2014/072173

§ 371 Date: Mar. 11, 2016

(30) Foreign Application Priority Data
Sep. 12, 2013 (JP) 2013-189727

(51) Int. Cl. G11B 5/64; G11B 5/851

(52) U.S. Cl. CPC G11B 5/647; G11B 5/851

(57) ABSTRACT

A perpendicular magnetic recording medium which has a magnetic layer comprising a material having FePt alloy as a main component on a substrate, characterized in that the magnetic layer is an FePtAg—C or FePt—C granular thin film obtained by laminating a unit in multiple stages, the unit being a laminate film obtained by forming, on an FePtAg—C layer or an FePt—C layer, at least one layer of (A) FePtAg layer or FePt layer or (B) FePtAg—C layer or FePt—C layer which has carbon concentration different from the above FePtAg—C layer or FePt—C layer. Consequently, a perpendicular magnetic recording medium using an FePtAg—C or FePt—C granular thin film which satisfies both the high order and columnar structure required for achieving recording density of more than 1 Tbit/in², for example, can be provided.

### TECHNICAL FIELD

The present invention relates to a perpendicular magnetic recording medium which is preferably mounted in a magnetic disk device such as a hard disk drive of perpendicular magnetic recording type (hereinbelow, it is suitably abbreviated as “HDD”) and a method for producing it.

### BACKGROUND ART

According to cloud computing and digitization of home electric appliances or the like, the amount of information handled all over the world is dramatically increasing. In this regard, a hard disk drive (HDD) is the most important device for storing those data. By having advantages such as low cost, high capacity, and non-volatility, the HDD has a high market share as a storage device for large volume data.

A part for recording information in HDD is referred to as a magnetic recording medium. A currently used medium has a micro structure in which CoCrPt alloy fine microparticles with size of about 8 nm are homogeneously dispersed in a non-magnetic matrix of SiO₂. Although the recording density is currently about 800 Gbit/in^{t}, it is expected to have the density of more than 1 Tbit/in². For achieving a medium with high density, additional micronization of CoCrPt alloy is needed.

However, since CoCrPt alloy has small magnetic anisotropy, at a size of 5 nm or less which is required for achieving 1 Tbit/in², there is a problem of a disturbance by caused heat in which probabilistic magnetization reversal occurs due to heat energy (KuV≦k_{B}T, KuV is anisotropic energy of ferromagnetic microparticles and k_{B}T is thermal energy). To overcome such a problem, it is necessary to use a material with high Ku for the medium.

Accordingly, what has recently received attention as a material with high Ku is FePt, having an ordered structure of L1₀ as described in Patent Literature 1, proposed by the present inventors. Since FePt has energy density of 7×10⁷ erg/cc and magnetic anisotropy which is one digit higher than that of CoCrPt alloy, it enables reducing the size to 4 nm.

By having high magnetic anisotropy, FePt receives attention over the last ten years or so as a recording medium, and studies are being made on it. However, when an FePt thin film is prepared by a sputtering method which is used for producing a medium, a disordered structure is formed as a high temperature phase. Since the heating treatment temperature for ordering them is high, it remained difficult to obtain a micro structure of particle dispersion type (i.e., granular film) that is suitable for the medium. The present inventors have proposed selecting C with a strong property of having phase separation from FePt and selecting MgO as an under layer for controlling orientation of FePt, to achieve the micro structure and magnetic properties that are applicable to a medium (for example, see Patent Literature 2 and Non Patent Literature 1).

However, when FePt is used, the magnetic field for magnetization reversal reached a high value of 30 kOe or more as the size of fine particles is reduced. Because it is a value higher than the magnetic field that can be generated by a magnetic head for recording (i.e., about 15 kOe), there is a problem of inability to achieve recording according to a current recording method.

As a new magnetic recording mode to solve the above problems, a heat assisted magnetic recording (HAMR) is proposed in which recording is performed after a medium is locally heated to temperature of Curie point (i.e., temperature at which ferromagnetism disappears) during recording (see, Patent Literature 3, for example). It is expected that FePt is used as a HMAR medium.

### CITATION LIST

### Patent Literature

Patent Literature 1: JP 2008-91009 A

Patent Literature 2: JP 2011-146089 A

Patent Literature 3: JP 2011-198455 A

### Non Patent Literature

Non Patent Literature 1: A. Perunal, Y. K. Takahashi, and K. Hono, Appl. Phys. Exp. 1, 101301 2008

Non Patent Literature 2: L. Zhang, Y. K. Takahashi, A. Perumal and K. Hono, J. Magn. Magn. Mater 322, 2658 (2010)

Non Patent Literature 3: B. S. D. Ch. S. Varaprasad, M. Chen, Y. K. Takahashi and K. Hono, IEEE Trans. Magn 49, 718 (2013).

### SUMMARY OF INVENTION

### Technical Problem

After the present inventors reported in Non Patent Literature 1, FePt—C granular thin film having fine particles and narrow dispersion, it was followed by all the hard disk manufacturers all over the world, and currently it is a standard specification of a heat assisted magnetic recording medium. The present inventors also proposed in Non Patent Literature 2 that, when Ag is added to an FePt—C granular thin film, both the high magnetic anisotropy and micro structure with fine particles and narrow distribution can be obtained. In order to make it commercially available, it is also necessary to reduce the noise, and a columnar structure with aspect ratio of 1 or so is needed. However, since an FePt—C or FePtAg—C granular thin film has film thickness of 6 nm or more in which the magnetic phase has a bilayer structure in thickness direction, the FePt particles in the second layer are not perpendicularly orientated so that the perpendicular anisotropy is impaired. For such reasons, there is a need for development of a technique for obtaining FePt particles with a columnar structure while suppressing growth of a bilayer structure.

Accordingly, to solve the above problems, present inventors conducted a test using an oxide which has lower tendency of phase separation from FePt. As a result, it was found that, when TiO or CrO is used, the columnar structure was achieved but the coercive force was significantly lowered (see, Non Patent Literature 3). That is because, as the metals constituting the oxide get dissolved in FePt particles, the driving force for ordering into L1₀ structure of FePt is weakened. In addition to the studies in which various non-magnetic matrixes are used, a thin FePt—C film is used as an under layer and FePt—TiO, FePt—SiO₂, or the like is formed into a film on it to achieve both the high order and columnar structure (see Non Patent Literature 3). However, none succeeded in solving of the problems described above.

The present invention is made to solve the above problems, and an object of the invention is to provide a perpendicular magnetic recording medium using an FePtAg—C or FePt—C granular thin film which satisfies both the high order and columnar structure that are required to achieve recording density of more than 1 Tbit/in², for example.

### Solution to Problems

As a result of intensive studies to solve the above problems of a related art, the present inventors invention found that, in a perpendicular magnetic recording medium having a magnetic layer comprising a material having FePt alloy as a main component on a substrate, by laminating, as a magnetic layer, FePtAg—C and FePt with thickness of 1 nm or so by alternating sputtering, FePtAg underwent phase separation from C in FePtAg—C during film growth so that the non-magnetic substance C became a matrix, a columnar structure in which FePtAg and FePt were alternately laminated was obtained, and an FePtAg—C columnar granular structure having average particle diameter of 9.2 nm and dispersion of 2.5 nm could be achieved. The present invention is achieved based on them.

It was also found that, in a perpendicular magnetic recording medium having a magnetic layer comprising a material having FePt alloy as a main component on a substrate, by laminating, as a magnetic layer, three kinds of FePtAg—C with thickness of 2 nm or so by sputtering such that the carbon concentration increased gradually from the substrate side, FePtAg underwent phase separation from C during film growth so that the non-magnetic substance C became a matrix, a columnar structure in which each FePtAg was laminated was obtained, and an FePtAg—C columnar granular structure having average particle diameter of 7.8 nm and dispersion of 1.8 nm could be achieved. The present invention is achieved based on them.

Namely, in order to solve the problems described above, the present invention has the following constitution or method.

[1] A perpendicular magnetic recording medium of the present invention is a perpendicular magnetic recording medium including at least a magnetic layer comprising a material including FePt alloy as a main component on a substrate, wherein the magnetic layer is an FePtAg—C or FePt—C granular thin film obtained by laminating a unit in multiple stages, the unit being a laminate film obtained by forming, on an FePtAg—C layer or an FePt—C layer, at least one layer of (A) FePtAg layer or FePt layer or (B) FePtAg—C layer or FePt—C layer which has carbon concentration different from the above FePtAg—C layer or FePt—C layer.

[2] According to the perpendicular magnetic recording medium of the present invention, in the configuration of [1], the magnetic layer is the FePtAg—C or FePt—C granular thin film obtained by laminating the unit in multiple stages, the unit being the laminate film obtained by forming, on the FePtAg—C layer or the FePt—C layer, the FePtAg layer or the FePt layer.

[3] According to the perpendicular magnetic recording medium of the present invention, in the configuration of [1], the magnetic layer is the FePtAg—C or FePt—C granular thin film obtained by laminating the unit in multiple stages, the unit being the laminate film obtained by laminating at least two layers of the FePtAg—C layer or the FePt—C layer in which carbon concentration increases gradually from the substrate side.

[4] According to the perpendicular magnetic recording medium of the present invention, in the configuration of any one of [1] to [3], film thickness of each layer constituting the magnetic layer is preferably 0.1 nm or more and less than 6 nm.

[5] According to the perpendicular magnetic recording medium of the present invention, in the configuration of any one of [1] to [4], it preferably has, on the substrate, at least a heat absorbing layer with high heat conductivity, a crystalline orientation control layer, and the magnetic layer in the order.

[6] According to the perpendicular magnetic recording medium of the present invention, in the configuration of any one of [1] to [5], the orientation control layer preferably has a lattice constant mismatch of 10% or less with FePt (001) of L1₀ structure.

[7] According to the perpendicular magnetic recording medium of the present invention, in the configuration of any one of [1] to [6], the magnetic layer is preferably a ferromagnetic layer of granular structure which has crystal particles having FePt alloy with L1₀ structure as a main component and a grain boundary part having non-magnetic substance C as a main component.

[8] The perpendicular magnetic recording medium of the present invention, in the configuration of any one of [1] to [7], preferably further includes, between the substrate and the orientation control layer, a soft magnetic layer in addition to the heat absorbing layer.

[9] A method for producing a perpendicular magnetic recording medium of the present invention is a method for producing a perpendicular magnetic recording medium having a magnetic layer which comprises at least FePt alloy as a main component on a substrate, wherein a film of an FePtAg—C layer or an FePt—C layer is formed by sputtering, on the substrate at substrate temperature of 600° C. or lower, at least one layer of (A) FePtAg layer or FePt layer or (B) FePtAg—C layer or FePt—C layer which has carbon concentration different from the above FePtAg—C layer or FePt—C layer is formed on the FePtAg—C layer or FePt—C layer by sputtering to give a laminate film as one unit, and the unit is laminated in multiple stages to form an FePtAg—C or FePt—C granular thin film.

[10] According to the method for producing a perpendicular magnetic recording medium of the present invention, in the method of [9], the film of the FePtAg—C layer or the FePt—C layer is formed by sputtering on the substrate at substrate temperature of 600° C. or lower, the film of FePtAg layer or the FePt layer is formed on the above the FePtAg—C layer or the FePt—C layer by sputtering to give the laminate film as one unit, and the unit is laminated in multiple stages to form the FePtAg—C or FePt—C granular thin film.

[11] According to the method for producing a perpendicular magnetic recording medium of the present invention, in the method of [9], at least two layers of the FePtAg—C layer or the FePt—C layer having gradually increasing carbon concentration from the substrate side are formed by sputtering on the substrate at substrate temperature of 600° C. or lower to give the laminate film as one unit, and the unit is laminated in multiple stages to form the FePtAg—C or FePt—C granular thin film.

[12] According to the method for producing a perpendicular magnetic recording medium of the present invention, in the method of any one of [9] to [11], film thickness of each layer constituting the magnetic layer is preferably 0.1 nm or more and less than 6 nm.

[13] According to the method for producing a perpendicular magnetic recording medium of the present invention, in the method of any one of [9] to [12], an annealing treatment is preferably performed at temperature of 600° C. or lower after the film forming.

### Advantageous Effects of Invention

According to the perpendicular magnetic recording medium of the present invention, even when the film thickness of an FePtAg—C or FePt—C granular thin film is 6 nm or more, a columnar structure with aspect ratio of 1 or more can be easily obtained without having a magnetic phase present as a bilayer structure in thickness direction. Thus, both the anisotropy with high noise resistance and microstructure with fine particles and narrow dispersion can be obtained. As such, according to the present invention, it is possible to provide a perpendicular magnetic recording medium using an FePtAg—C or FePt—C granular thin film which has both the high order and columnar structure that are required to achieve recording density of more than 1 Tbit/in², for example.

### BRIEF DESCRIPTION OF THE DRAWINGS

FIG. 1 is a diagram schematically illustrating a layer structure of an FePtAg—C granular thin film of the first embodiment of the present invention;

FIG. 2 is a diagram schematically illustrating a layer structure of an FePtAg—C granular thin film of the second embodiment of the present invention;

FIGS. 3(a) and 3(b) are photographs showing the TEM image of an FePtAg—C/FePt multilayer which is formed on an MgO single crystal substrate of Example 1 of the present invention, in which FIG. 3(a) indicates an in-plane TEM image and FIG. 3(b) indicates a cross-sectional TEM image;

FIG. 4 is a drawing illustrating the magnetization curve of FePtAg—C/FePt multilayer in in-plane and perpendicular direction;

FIGS. 5(a) to 5(e) are drawings illustrating an FePtAg—C granular thin film which is formed on a heat resistant glass substrate, in which FIG. 5(a) indicates an in-plane TEM image, FIG. 5(b) indicates a cross-sectional TEM image, FIG. 5(c) indicates a magnetization curve, FIG. 5(d) indicates particle dispersion, and FIG. 5(e) indicates X ray diffraction pattern;

FIG. 6 includes drawings illustrating a TEM image (upper panel indicates an in-plane TEM image and lower panel indicates a cross-sectional image), magnetization curve in in-plane and perpendicular direction, and particle dispersion of an FePtAg—C multilayer which is formed on an MgO single crystal substrate of Example 3 of the present invention;

FIG. 7 is a photograph showing the planar TEM image of an FePt—C granular thin film with film thickness of 6 nm or film thickness of 10 nm as a comparative example of the present invention; and

FIG. 8 is a photograph showing the cross-sectional TEM image of an FePt—C granular thin film with film thickness of 6 nm or film thickness of 10 nm as a comparative example of the present invention.

### Description of Embodiment

A perpendicular magnetic recording medium of the present invention is a perpendicular magnetic recording medium including at least a magnetic layer comprising a material including FePt alloy as a main component on a substrate, wherein the magnetic layer is an FePtAg—C or FePt—C granular thin film obtained by laminating a unit in multiple stages, the unit being a laminate film obtained by forming, on an FePtAg—C layer or an FePt—C layer, at least one layer of (A) FePtAg layer or FePt layer or (B) FePtAg—C layer or FePt—C layer which has carbon concentration different from the above FePtAg—C layer or FePt—C layer.

Hereinbelow, embodiments of the present invention are explained in detail.

First, the first embodiment of the present invention is explained.

The perpendicular magnetic recording medium of the first embodiment of the present invention is characterized in that, in a perpendicular magnetic recording medium containing at least a magnetic layer comprising a material containing FePt alloy as a main component on a substrate, the magnetic layer is an FePtAg—C or FePt—C granular thin film which is obtained by laminating a unit in multiple stages, the unit being a laminate film of an FePtAg—C layer or an FePt—C layer and an FePtAg or an FePt layer.

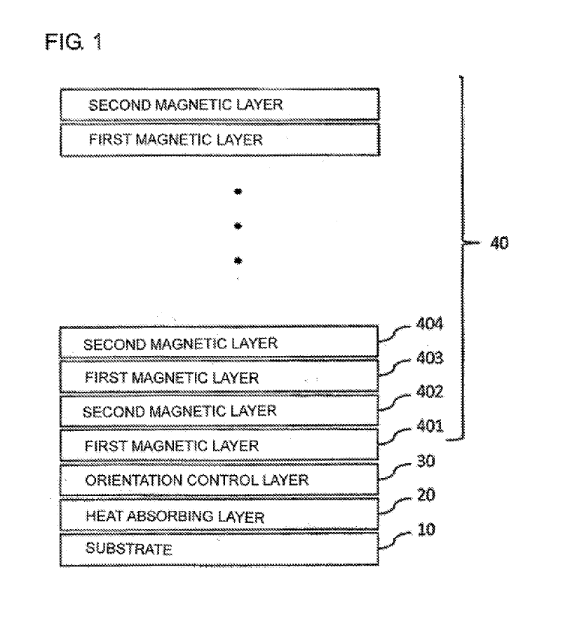

FIG. 1 is a diagram schematically illustrating a lamination state of the perpendicular magnetic recording medium of the first embodiment of the present invention. As shown in the drawing, the perpendicular magnetic recording medium of this embodiment has at least, on a substrate 10, a heat absorbing layer 20 with high heat conductivity, a crystalline orientation control layer 30, and a magnetic layer 40 (perpendicular magnetic recording layer) comprising a material having FePt alloy as a main component in this order.

As the substrate 10, a single crystal MgO substrate or a glass substrate is preferably used. Examples of glass for substrate include aluminosilicate glass, alum inoborosilicate glass, soda lime glass, or the like. Among them, aluminosilicate glass is preferable. Furthermore, amorphous glass or crystallized glass can be used. Chemically reinforced glass is preferable for high stiffness. In the present invention, surface roughness of a main substrate surface is preferably 10 nm or less in terms of Rₘₐₓ and 0.3 nm or less in terms of Ra.

On the substrate 10, the heat absorbing layer 20 is formed. Since the recording region temporarily experiences high temperature of 600 K or more due to laser used upon recording to the medium, the heat absorbing layer 20 plays a role of releasing the heat. As for the material of the heat absorbing layer 20, a material with high heat conductivity can be used. Specific examples thereof include a metal such as NiTa. Film thickness of the heat absorbing layer 20 is preferably in the range of from 50 to 100 nm. The heat absorbing layer 20 can be formed by using a sputtering method.

On the heat absorbing layer 20, the crystalline orientation control layer 30 is formed. The orientation control layer 30 is preferably used for controlling the perpendicular orientation of an easy magnetization layer with L1₀ crystal structure (i.e., allowing the crystal orientation to have perpendicular orientation to substrate surface) in a magnetic layer which comprises a material having at least FePt alloy as a main component, homogeneous micronization of crystal particle diameter, and grain boundary segregation during forming a granular structure. The orientation control layer 30 may include elemental Mg metal, MgAl alloy, or the like but not it is not limited thereto. In the present invention, as a material of the orientation control layer 30, MgO, MgAl₂O₄, Mg—Ti—O, CrRu, AlRu, Pt, Cr, or the like are specifically used, but it is not limited thereto. It is particularly preferable in the present invention that, the lattice mismatch between the orientation control layer 30 and FePt (001) of L1₀ structure in a magnetic layer 40 of the upper layer is 10% or less. As the orientation control layer 30 has lattice mismatch in the above range with FePt in the magnetic layer 40, a disturbance in crystal orientation of the magnetic layer 40, which comprises the material containing FePt as a main component, is suppressed by the orientation control layer 30, and thus the effect of improving the microstructure is exhibited well.

Meanwhile, in the present invention, the orientation control layer 30 may comprise a single layer only or multiple layers. In case of multiple layers, combination of the same kind of materials or combination of different kind of materials may be used.

Furthermore, film thickness of the orientation control layer 30 is, although it is not particularly limited, preferably minimum film thickness that is at least required for controlling the structure of a perpendicular magnetic recording layer, and it is preferably in the range of from 5 to 30 nm in total, for example. The orientation control layer 30 may be formed by using a sputtering method.

The magnetic layer 40 (perpendicular magnetic recording layer) is the most characteristic layer of the present invention, and it comprises of a material having FePt alloy as a main component. Since FePt alloy has high crystal magnetocrystalline anisotropy constant (Ku) and thus can surely have heat stability even when magnetic particles are micronized, it is suitable for recording with high density by a magnetic recording medium. More specifically, the magnetic layer 40 comprises an FePtAg—C or FePt—C granular thin film which is obtained by laminating a unit in multiple stages, the unit being a laminate film of a first magnetic layer 401, 403 . . . comprising an FePtAg—C layer or an FePt—C layer with film thickness of 0.1 nm or more and less than 6 nm and a second magnetic layer 402, 403 . . . comprising an FePtAg layer or an FePt layer with film thickness of 0.1 nm or more and less than 6 nm. When each magnetic layer is formed by a DC magnetron sputtering method, in particular, a homogeneous film can be formed, and thus desirable.

C in the FePtAg—C layer or FePt—C layer of the first magnetic layer undergoes phase separation from FePtAg or FePt during film growth, and it forms a non-magnetic matrix with granular structure. Furthermore, as FePtAg or FePt is laminated with controlled orientation on the FePtAg or FePt of the first magnetic layer to form a columnar alternating sputtering laminated film, an FePtAg—C or FePt—C granular thin film is yielded.

The granular thin film comprising the magnetic layer 40 of the first embodiment preferably contains Ag for the purpose of accelerating the ordering of the L1₀ structure of FePt. In that case, Ag is preferably contained at ratio of 0 to 20% in terms of atomic ratio to FePt. Furthermore, as ordering of the L1₀ structure of FePt is accelerated by containing Ag, there is also an advantage that the annealing treatment temperature after forming a magnetic film can be lowered than before.

The FePt layer or FePtAg layer of the second magnetic layer in the magnetic layer 40 of the first embodiment prevents precipitation of C on particle surface, and thus it functions as a carbon precipitation preventing layer for maintaining the granular structure. Accordingly, a columnar structure having FePt as a main component is achieved in an FePtAg—C or FePt—C granular thin film.

In the magnetic layer 40, a laminate film of one unit having the first magnetic layer comprising an FePtAg—C layer or an FePt—C layer and the second layer comprising an FePtAg layer or an FePt layer of which film thickness is 0.1 nm or more and less than 6 nm can be preferably laminated repeatedly with two or more units. The magnetic layer 40 can be formed to have entire film thickness in the range of from 10 nm or more to 30 nm or less, for example. With such a film thickness, strong signal intensity is shown so that a sufficient SN can be obtained. Furthermore, as surface roughness is suppressed, a possibility of having collision with a head can be avoided. The number of repetition is suitably set depending on the film thickness of the first magnetic layer and the second magnetic layer. For example, when the first magnetic layer has film thickness of 0.25 nm and the second magnetic layer has film thickness of 0.15 nm and both layers are laminated 30 times, the thickness of the magnetic layer 40 reaches 12 nm.

The magnetic layer 40 of the first embodiment is a ferromagnetic layer of granular structure which has crystal particles having FePt alloy as a main component (including repeated structure of FePtAg/FePt laminate film) and a grain boundary part (i.e., matrix) having non-magnetic substance C as a main component.

The reason for having the film thickness of less than 6 nm for the magnetic layer 40 of the first embodiment is that, when it is 6 nm or more, FePt—C and FePtAg—C form a bilayer. Furthermore, the reason for having the film thickness of 0.1 nm or more is that it corresponds to the thickness of a single atomic layer. The magnetic layer 40 has composition satisfying the following formula.

(FeₓPt₁₋ₓ)_{1-Z}Ag_{Z}13 Cᵥ (1)

In the above formula, 0.4<x<0.55, 0≦z<0.2, and 30% by volume <v<50% by volume. (FeₓPt₁₋ₓ)_{1-Z}Ag_{Z} is (100-v)% by volume.

On top of the substrate 10, a soft magnetic layer is preferably formed to suitably control the magnetic circuit of a perpendicular magnetic recording layer (not illustrated). The soft magnetic layer is preferably constituted such that, by interposing a non-magnetic spacer layer between a first soft magnetic layer and a second soft magnetic layer, an AFC (Antiferro-magnetic exchange coupling) is provided. Accordingly, the magnetization direction of the first soft magnetic layer and the second magnetic layer is aligned and fixed in an anti-parallel manner with high accuracy so that a noise generated from the soft magnetic layer can be reduced. For example, as a composition of the first soft magnetic layer and the second soft magnetic layer, an FeTa-based material such as FeTaC and FeTaN, and a Co- and CoFe-based material such as CoTaCoTaZr, CoFeTaZr, and CoFeTaZrAlCr may be used. In the present invention, as a material of a soft magnetic layer, a material capable of maintaining the soft magnetic property according to crystallization during heat treatment (i.e., nano crystallization) is preferably used. It is preferable to have a soft magnetic layer which at least contains Fe, at least one element selected from Ta, Hf, and Zr, and at least one element selected from C and N.

As for the order for laminating the soft magnetic layer and the heat absorbing layer 20, any one of them may be present to be close to the substrate 10.

Meanwhile, the FeTa material is preferable in that the soft magnetic property is enhanced by a heat treatment. The FeTa material is also preferable in that, by further containing C or N, the soft magnetic property is enhanced. Furthermore, the composition of the spacer layer may comprise Ru (ruthenium) or an alloy of Ru, but addition elements may be mixed to control the exchange binding constant.

Film thickness of the soft magnetic layer varies depending on its structure or the structure or property of a magnetic head. However, it is preferably from 15 nm to 200 nm in total. Meanwhile, although the film thickness may be slightly different between the upper and lower layers to have optimized recording and reproduction, it preferably has the same thickness. The soft magnetic layer may be formed by a plating or a sputtering method, for example.

It is also preferable that an adhesion layer is formed between the substrate 10 and the soft magnetic layer. By forming the adhesion layer, the adhesiveness between the substrate 10 and the soft magnetic layer is enhanced so that the release of the soft magnetic layer can be prevented. As for the material of the adhesion layer, a material containing Ti may be used, for example. Film thickness of the adhesion layer is preferably from 0 to 10 nm or so. The adhesion layer may be formed by a sputtering method, for example.

Furthermore, a seed layer comprising amorphous ceramic material is preferably formed. The seed layer has a function of controlling (improving) orientation and crystallinity, and also the micro structure of the fine particles of the orientation control layer 30 in the upper layer. As for the material of the seed layer, it may be selected from Si, Al, or the like, for example. Furthermore, an oxide in which oxygen is contained in those elements may be also used (i.e., oxygen-containing ceramics). For example, amorphous SiO₂, Al₂O₃, or the like may be preferably selected. Film thickness of the seed layer is preferably such that it is the minimum thickness required for performing control of crystal growth of the orientation control layer 30 in the upper layer. Film thickness of the seed layer is preferably from 0 to 10 nm or so. The seed layer may be formed by an RF sputtering method, for example.

It is also possible to form an auxiliary recording layer in the upper or lower part of the magnetic layer 40. By forming the auxiliary recording layer, the magnetic recording layer can also have resistance to high temperature in addition to high-density recording property, low noise property, and coercive force control. Composition of the auxiliary recording layer may be a ferromagnetic alloy containing FePt with Al structure. In addition, instead of forming a film of a ferromagnetic layer, it is possible to control the coercive force by disordering, according to ion irradiation or plasma damage, part of the FePt magnetic material with L1₀ structure to A1 structure. Film thickness of the auxiliary recording layer is preferably from 0 to 10 nm or so. The auxiliary recording layer may be formed by a sputtering method, for example.

It is also possible to form additionally an exchange coupling control layer between the magnetic layer 40 and the auxiliary recording layer. By forming the exchange coupling control layer, the strength of an exchange coupling strength between the magnetic layer 40 and the auxiliary recording layer is controlled, and thus the recording reproduction property can be optimized. As for the exchange coupling control layer, (Ru or Ru alloy) is preferably used, for example. Film thickness of the exchange coupling control layer is preferably from 0 to 10 nm or so. The exchange coupling control layer may be formed by a sputtering method, for example.

Furthermore, it is preferable to form a protective layer on the magnetic layer 40 (perpendicular magnetic recording layer). By forming the protective layer, a surface of the magnetic recording medium can be protected from the magnetic head which floats and flies above the magnetic recording medium. As for the material of the protective layer, a carbon based protective layer is preferable, for example. Furthermore, film thickness of the protective layer is preferably from 3 to 7 nm or so. The protective layer may be formed by a plasma CVD method or a sputtering method, for example.

Furthermore, it is preferable to form a lubricating on top of the protective layer. By forming a lubricating layer, wearing between the magnetic head and magnetic recording medium is suppressed so that the durability of the magnetic recording medium can be enhanced. As for the material of the lubricating layer, a perfluoropolyether (PFPE) based compound is preferably used, for example. Furthermore, the lubricating layer can be formed by a dip coating method, for example. The film thickness of the lubricating layer is preferably from 0 to 10 nm or so.

Next, explanations are given for the method for producing a perpendicular magnetic recording medium of the first embodiment.

The method for producing the perpendicular magnetic recording medium of the first embodiment of is characterized in that, basically as a method for producing a perpendicular magnetic recording medium having a magnetic layer which comprises of a material having at least FePt alloy as a main component on a substrate, a film of an FePtAg—C layer or an FePt—C layer is formed by sputtering on the substrate at substrate temperature of 600° C. or lower, an FePtAg layer or an FePt layer is formed by sputtering on the FePtAg—C layer or FePt—C layer to give a laminate film as one unit, and the unit is laminated in multiple stages to form an FePtAg—C or FePt—C granular thin film. Film thickness of each layer constituting the magnetic layer is 0.1 nm or more and less than 6.0 nm. Film forming is performed at growth rate which has been previously determined in inert gas atmosphere such as Ar.

In the present invention, it is important that film forming of the magnetic layer 40 is performed at substrate surface temperature of 600° C. or lower, and preferably in the range of from 350° C. to 600° C. For example, if the film forming rate of the magnetic layer 40 is high so that the substrate before film forming of the magnetic layer 40 is heat-treated at predetermined temperature of 600° C. or lower, heating of the substrate during film forming of the magnetic layer 40 is not essential if the temperature decrease on the substrate is small until the completion of film forming of the magnetic layer 40. Meanwhile, if the film forming rate of the magnetic layer 40 is small so that the temperature decrease on the substrate is non-negligible until the completion of film forming of the magnetic layer 40 even when the substrate is heated at predetermined temperature of 600° C. or lower before film forming of the magnetic layer 40, it is preferable that the substrate is heated even during film forming of the magnetic layer 40.

Furthermore, if necessary, the substrate may be subjected to a heat treatment after film forming of the magnetic layer 40 (in the present invention, the heat treatment after film forming of the magnetic layer 40 is specifically referred to as an “annealing treatment”). In the present invention, the annealing treatment temperature may be 600° C. or lower. In particular, when the substrate temperature during film forming of a magnetic layer is 400° C. or lower, there may be a case in which magnetic field Hn for producing nucleus with magnetization reversal is insufficient. Thus, for such a case, it is preferable to perform the annealing treatment only after film forming of the magnetic layer 40.

According to the above method for production, the perpendicular orientation of an easy magnetization layer with L1₀ crystal structure in a magnetic layer 40 (perpendicular magnetic recording layer) which comprises a material having at least FePt alloy as a main component, micronized structure (i.e., homogeneous micronization) of crystal particle diameter (i.e., homogeneous micronization), or the like are suitably controlled, and thus a perpendicular magnetic recording medium having a granular film, which has excellent magnetic properties (in particular, optimized coercive force (Hc) and magnetic field (Hn) for producing nucleus with magnetization reversal) and is useful for dealing with recording with even higher density, can be provided. Furthermore, according to the method for producing a perpendicular magnetic recording medium of the present invention, it is possible to have micronization of magnetic particle size while maintaining high Ku and improvement of crystal orientation of a magnetic layer. Thus, excellent magnetic properties can be obtained.

In addition to the basic configuration described above, the perpendicular magnetic recording medium of the first embodiment may adopt various layer configurations for having an improvement of new magnetic properties. As a typical example, it is possible to laminate, on the substrate 10, the heat absorbing layer 20, the crystalline orientation control layer 30, and the magnetic layer 40 (perpendicular magnetic recording layer) comprising a material having FePt alloy as a main component in the order by sputtering film forming process, as it is diagrammatically shown in FIG. 1.

Furthermore, in addition to the configuration of FIG. 1, a desired perpendicular magnetic recording medium may be obtained by forming, on the substrate 10, an adhesion layer, the heat absorbing layer 20, a seed layer, the orientation control layer 30, or the like in the order by using a sputtering method, performing a heat treatment of the substrate 10 at predetermined temperature of 600° C. or lower after the film forming of the orientation control layer 30 but before the film forming of the magnetic layer 40, and performing film forming of the magnetic layer 40 on the orientation control layer 30.

Furthermore, in addition to the above configuration, a perpendicular magnetic recording medium with various layer constitutions may be achieved according to suitable film forming of each layer described above.

Next, explanations are given for the second embodiment of the present invention.

The perpendicular magnetic recording medium of the second embodiment of the present invention is characterized in that, in a perpendicular magnetic recording medium which has a magnetic layer comprising a material having FePt alloy as a main component on a substrate, the magnetic layer film is an FePtAg—C or FePt—C granular thin film which is obtained by having a laminate film as a unit in which at least two layers of an FePtAg—C layer or an FePt—C layer are laminated while carbon concentration increases gradually from the substrate side and by laminating the unit in multiple stages.

The perpendicular magnetic recording medium of the second embodiment is different from the perpendicular magnetic recording medium of the first embodiment only in terms of the structure of the magnetic layer, and other structures remain the same. Thus, to avoid repeated explanations, in the following the descriptions are given mainly for the magnetic layer.

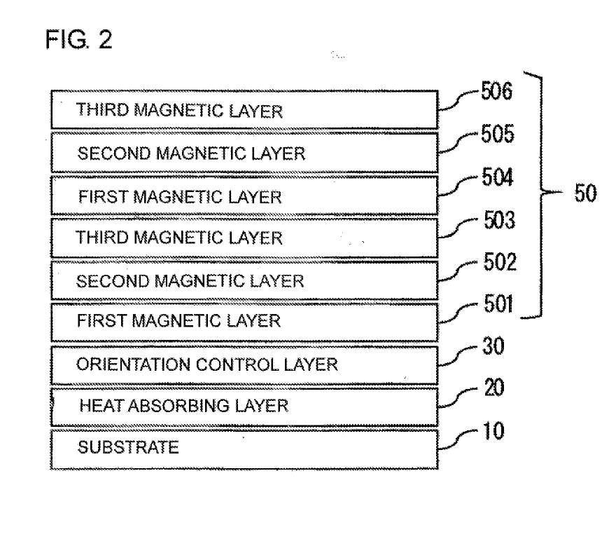

FIG. 2 is a cross-sectional drawing schematically illustrating the laminated layer structure of a perpendicular magnetic recording medium according to the second embodiment of the present invention. As shown in the drawing, the perpendicular magnetic recording medium of this embodiment is provided with, on the substrate 10, at least the heat absorbing layer 20 with high heat conductivity, the crystalline orientation control layer 30, and the magnetic layer 50 (perpendicular magnetic recording layer) comprising of a material having FePt alloy as a main component in the order.

The magnetic layer 50 (perpendicular magnetic recording layer) is the most characteristic layer of the present invention, and it comprises a material having FePt alloy as a main component. Because FePt alloy has high magnetocrystalline anisotropy constant (Ku) and thus can surely have heat stability even when magnetic particles are micronized, it is suitable for recording with high density using a magnetic recording medium. More specifically, the magnetic layer 50 comprises an FePtAg—C or FePt—C granular thin film which is obtained by sputtering laminated layers of a first magnetic layer 501, 504 . . . , a second magnetic layer 502, 505 . . . , and a third magnetic layer 503, 506 . . . , i.e., three layers of FePtAg—C layer or FePt—C layer in which carbon concentration increases in the order from the substrate 10 side. Namely, the first magnetic layer 501, the second magnetic layer 502, and the third magnetic layer 503 in which carbon concentration increases in the order from the substrate 10 side consist of one unit, while the first magnetic layer 504, the second magnetic layer 505, and the third magnetic layer 506 in which carbon concentration increases in the order from the substrate 10 side comprise one unit, and those two units are laminated in two stages. It is needless to say that the above configuration is a mere exemplification, and it is possible to have suitably the layers with different carbon concentration or a suitable stage number. Each layer constituting the magnetic layer 50 has film thickness of 0.1 nm or more and less than 6 nm. When each magnetic layer is formed by a sputtering method, in particular by a DC magnetron sputtering method, a homogeneous film can be formed, and thus desirable.

C in the FePtAg—C layer or FePt—C layer of the first to third magnetic layers undergoes phase separation from FePtAg or FePt during film growth, and it forms a non-magnetic matrix with granular structure. In addition, as the FePtAg or FePt obtained after phase separation in the second magnetic layer is laminated with controlled orientation on the FePtAg or FePt of the first magnetic layer, the FePtAg or FePt obtained after phase separation in the third magnetic layer is laminated with controlled orientation thereon, and a columnar alternating sputtering laminated film is formed to yield an FePtAg—C or FePt—C granular thin film.

The granular thin film constituting the magnetic layer 50 of the second embodiment preferably contains Ag for the purpose of accelerating the ordering of L1₀ structure of FePt. In that case, Ag is preferably contained at ratio of from 0 to 20% in terms of atomic ratio compared to FePt. Furthermore, as the ordering of the L1₀ structure of FePt is accelerated by containing Ag, there is also an advantage that the annealing treatment temperature after forming a magnetic film can be lowered than before.

When the carbon concentration in the first to third layers of the magnetic layer 50 of the second embodiment is set such that it increases in the order from the substrate 10 side, segregation of C on a surface of FePt particles is suppressed so that a columnar structure having FePt as a main component is achieved in the FePtAg—C or FePt—C granular thin film. The carbon concentration in the first to third layers is, from the viewpoint of having excellent particle dispersion and separation property, in the range of from 20% by volume to 40% by volume. Concentration difference between each layer is preferably in the range of from 5% by volume to 10% by volume to have an FePtAg—C or FePt—C granular thin film with excellent properties.

In the magnetic layer 50, a laminate film comprising the first to third magnetic layers, which comprises an FePtAg—C layer or an FePt—C layer and has film thickness of 0.1 nm or more and less than 6 nm, may be a single layer (i.e., one set), or multiple layers (i.e., multiple sets) may be laminated repeatedly. The magnetic layer 50 may be formed to have entire film thickness in the range of from 10 nm or more to 30 nm or less, for example. With such a film thickness, strong signal intensity is shown so that a sufficient SN can be obtained. Furthermore, as surface roughness is suppressed, a possibility of having collision with a head can be avoided. The number of repetition is suitably set depending on the film thickness of the first to third magnetic layers. For example, when each of the first to third magnetic layers has film thickness of 2.0 nm and a laminate film of those three layers are laminated twice, the thickness of the magnetic layer 50 reaches 12 nm. It is needless to say that the repetition number may be increased if the film thickness of the first to third layers is decreased.

The magnetic layer 50 of the second embodiment is a ferromagnetic layer of granular structure which has crystal particles having FePt alloy as a main component and a grain boundary part (i.e., matrix) having non-magnetic substance C as a main component.

The reason for having film thickness of less than 6 nm for the magnetic layer 50 of the second embodiment is that, when FePt—C and FePtAg—C are more than 6 nm, a bilayer structure is yielded. Furthermore, the reason for having film thickness of 0.1 nm or more is that it corresponds to thickness of a single atomic layer. The magnetic layer 50 has composition satisfying the following formula.

(FeₓPt₁₋ₓ)_{1-Z}Ag_{Z}—Cᵥ (2)

In the above formula, 0.4<x<0.55, 0≦z<0.2, and 30% by volume <v<50% by volume. (FeₓPt₁₋ₓ)_{1-Z}Ag_{Z} is (100-v)% by volume.

The first to third layers of the magnetic layer 50 of the second embodiment can be formed by the same film forming method as the first embodiment.

Meanwhile, the perpendicular magnetic recording medium of the present invention can be also applied to an ECC medium (i.e., Exchange Coupled Composite medium). An ECC medium is a medium having a thin soft magnetic anisotropic material applied to a medium for improving a signal to noise ratio (SNR).

### EXAMPLES

Hereinbelow, the embodiments of the present invention are explained in greater detail in view of the examples and comparative examples, and also the working effects of the present invention are illustrated.

### Example 1

On an MgO (001) single crystal substrate in a chamber, FePtAg—C and FePt were repeatedly laminated (30 times) by alternating sputtering using a DC magnetron sputtering method to have film thickness of 0.25 nm and 0.15 nm for each. As a result, an FePtAg—C granular thin film with film thickness of 12 nm was formed and a perpendicular magnetic recording medium of Example 1 was produced. The FePtAg—C layer was formed into a film, in Ar gas atmosphere (pressure of 0.5 Pa), at conditions including substrate surface temperature of 600° C. and film forming rate of 0.017 nm/s. The FePt layer was formed into a film, in Ar gas atmosphere (pressure of 0.5 Pa), at conditions including substrate surface temperature of 600° C. and film forming rate of 0.017 nm/s.

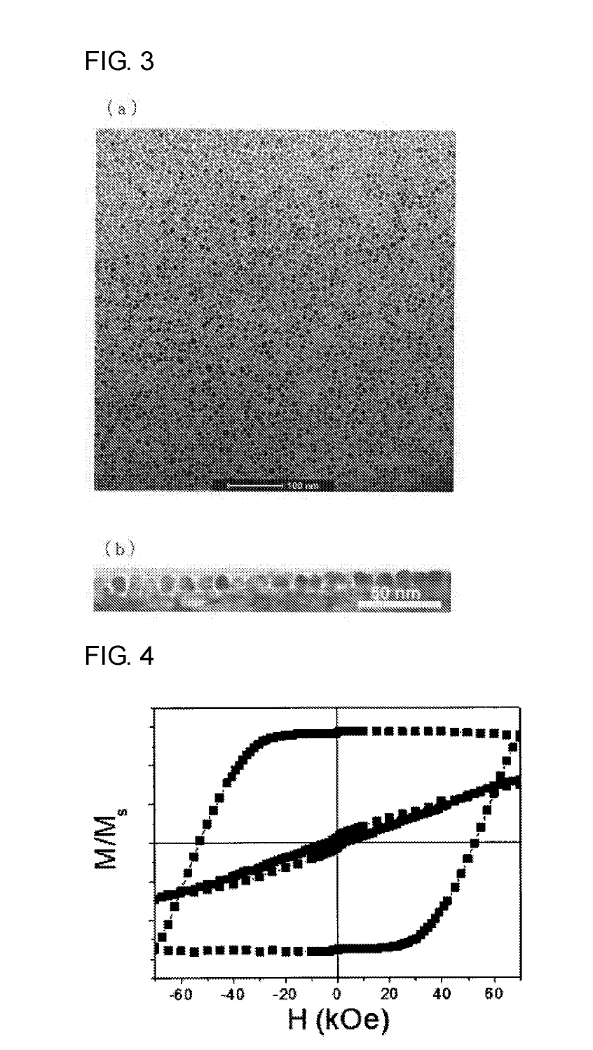

FIGS. 3(a) and 3(b) show a TEM image of an FePtAg—C/FePt multilayer film which has been produced in the above, in which FIG. 3(a) indicates a in-plane TEM image and FIG. 3(b) indicates a cross-sectional TEM image. As the FePt particle has the particle diameter of 9.2 nm and dispersion of 2.5 nm, it was confirmed that a structure with excellent particle dispersion property is formed. As described herein, the particle diameter means an average particle diameter of a particle that is measured based on in-plane TEM image. Furthermore, from the cross-sectional TEM image, it was confirmed that there is a columnar structure with aspect ratio of about 1.0. Accordingly, an example satisfying all of the particle distribution property and particle separation property and columnar structure is firstly achieved by the present invention as far as the present inventors are aware of.

FIG. 4 is a drawing illustrating the magnetization curve both in planar and perpendicular direction of FePtAg—C/FePt multilayer film, in which the horizontal axis represents the magnetic field [kOe] and the vertical axis represents magnetization which has been normalized based on saturated magnetization. In the drawing, the loop curve with high hysteresis represents the magnetization curve in the perpendicular direction. Meanwhile, the approximately linear curve having low hysteresis represents the magnetization curve in the in-plane direction. The coercive force exhibited a high value of about 50 kOe.

### Example 2

On a heat resistant glass substrate in a chamber, an amorphous NiTa layer was formed as a heat absorbing layer by a DC magnetron sputtering method at conditions including room temperature, Ar gas atmosphere (pressure of 0.8 Pa), and film forming rate of 0.056 nm/s to have film thickness of 50 nm. Then, on the amorphous NiTa film formed in the above, a crystalline MgO layer was formed as an orientation control layer by an RF sputtering method at conditions including room temperature, Ar gas atmosphere (pressure of 1.3 Pa), and film forming rate of 0.01 nm/s to have film thickness of 5 nm. Then, FePtAg—C and FePt were repeatedly laminated (30 times) on the MgO layer by alternating sputtering using a DC magnetron sputtering method to have film thickness of 0.25 nm and 0.15 nm, respectively. As a result, an FePtAg—C granular thin film with film thickness of 12 nm was formed and a perpendicular magnetic recording medium of Example 1 was produced. The FePtAg—C layer was formed into a film, in Ar gas atmosphere (pressure of 5 Pa), at conditions including substrate surface temperature of 600° C. and film forming rate of 0.017 nm/s. The FePt layer was formed into a film, in Ar gas atmosphere (pressure of 5 Pa), at conditions including substrate surface temperature of 600° C. and film forming rate of 0.017 nm/s.

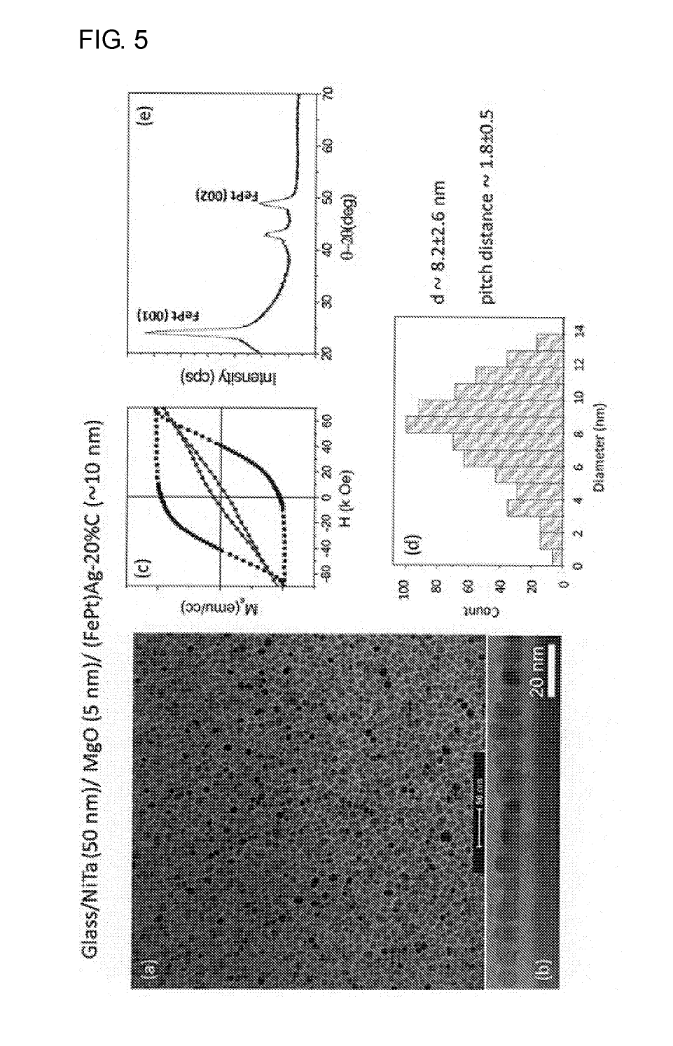

In FIGS. 5(a) and 5(b), a planar TEM image and a cross-sectional TEM image of an FePtAg—C granular thin film which has been produced in the above were shown. In FIG. 5(c), a magnetization curve in planar and perpendicular direction is shown. In FIG. 5(d), the particle dispersion was shown, and in FIG. 5(e), an X ray diffraction pattern was shown. In FIG. 5(c), the loop curve with high hysteresis indicates the magnetization curve in perpendicular direction. In contrast, an approximately linear curve with low hysteresis indicates the magnetization curve in in-plane direction.

From FIGS. 5(a), 5(b), and 5(d), it was shown that the FePt particles have particle diameter of 8.2 nm and dispersion of 2.6 nm, demonstrating that a structure with a very excellent particle dispersion property and separation property is formed. From the cross-sectional TEM image, it was confirmed that a columnar structure with aspect ratio of about 1.0 is formed. Furthermore, from the magnetization curve shown in FIG. 5(c), it was found that the thin film exhibits very strong magnetic anisotropy and the coercive force has a high value of about 44 kOe. Furthermore, from FIG. 5(e), (001) ordered reflection line was clearly observed. In this regard, although a heat resistant glass substrate is used herein, since crystalline MgO is formed into a film as an orientation control layer, FePt exhibits strong c plane orientation as shown in the X ray diffraction pattern.

### Example 3

FePt—C_{25 vol %} as a first magnetic layer, FePt—C_{30 vol %} as a second magnetic layer, and FePt—C_{35 vol %} as a third magnetic layer were laminated on an MgO (001) single crystal substrate in a chamber by alternating sputtering using a DC magnetron sputtering method to have film thickness of 2 nm for each. This lamination was repeated two times to form an FePt—C granular thin film with film thickness of 12 nm and a perpendicular magnetic recording medium of Example 3 was produced. Each FePt—C layer was formed into a film in Ar gas atmosphere (pressure of 5 Pa), at conditions including substrate surface temperature of 600° C. and film forming rate of 0.017 nm/s. The FePt layer was formed into a film, in Ar gas atmosphere (pressure of 5 Pa), at conditions including substrate surface temperature of 600° C. and film forming rate of 0.017 nm/s. Composition of the magnetic layer was [FePt—C_{25 vol %}/FePt—C_{35 vol %}/FePt—C_{35 vol %}]₂.

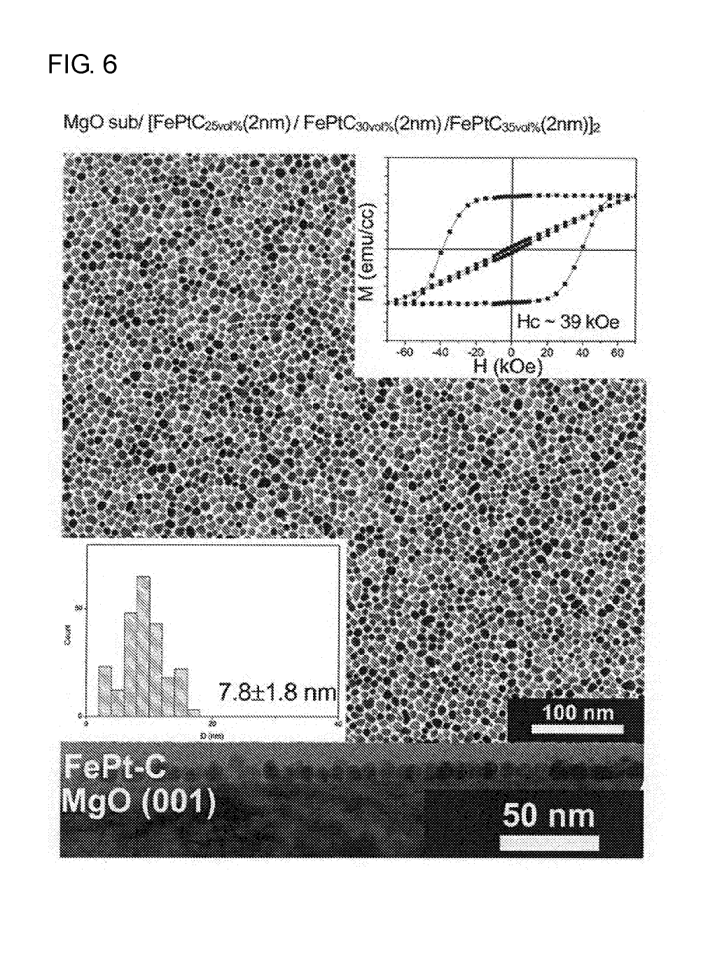

In FIG. 6, a planar (top panel) or a cross-sectional (bottom panel) TEM image of FePtAg—C (with varying carbon concentration) multilayer film prepared above is shown. On the top right corner of FIG. 6, the magnetization in in-plane and perpendicular direction is shown. On the bottom left corner of FIG. 6, particle dispersion is shown. In the magnetization curve of FIG. 6, the loop curve with high hysteresis indicates the magnetization curve in perpendicular direction. In contrast, an approximately linear curve with low hysteresis indicates the magnetization curve in in-plane direction.

From the TEM image of FIG. 6, it was shown that the FePt particles have particle diameter of 7.8 nm and dispersion of 1.8 nm, demonstrating that a structure with a very excellent particle dispersion property and separation property is formed. From the cross-sectional TEM image, it was confirmed that a columnar structure with aspect ratio of about 1.4 is formed. Furthermore, from the magnetization curve shown in FIG.6, it was found that the thin film exhibits very strong magnetic anisotropy and the coercive force has a high value of about 39 kOe.

### COMPARATIVE EXAMPLE

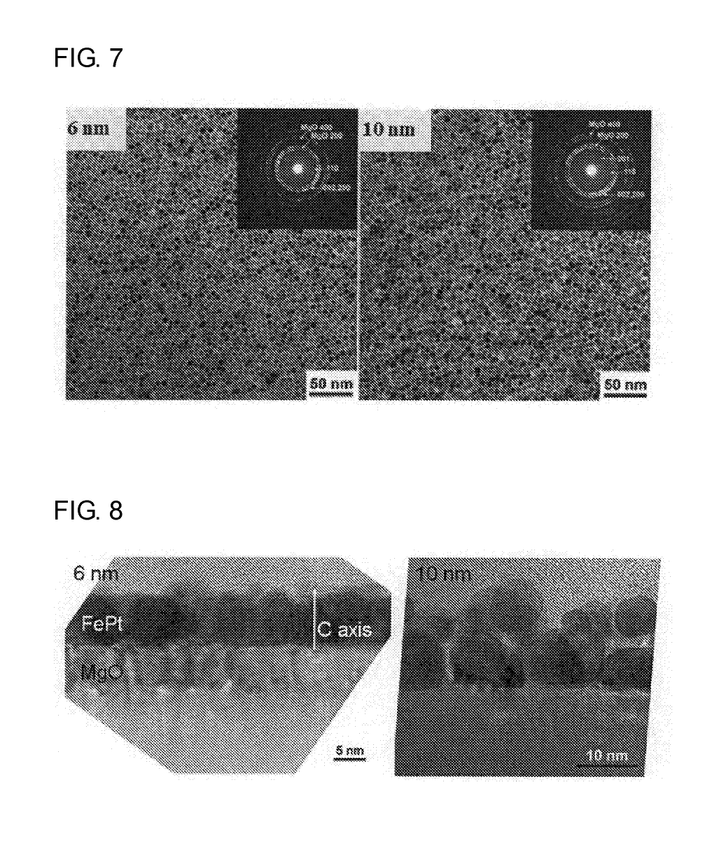

FIG. 7 shows a planar TEM image of an FePt—C granular thin film with film thickness of 6 nm or film thickness of 10 nm which has been produced according to a conventional method. FIG. 8 shows a cross-sectional TEM image of an FePt—C granular thin film with film thickness of 6 nm or film thickness of 10 nm of FIG. 7. The film constitution is as follows: thermally oxidized Si substrate/MgO (10 nm)/FePt—C_{50 vol %}.

When the film thickness is 6 nm, the average particle diameter was about 6 nm and dispersion was about 1.2 nm, demonstrating that a structure with excellent particle dispersion property is formed. It was also found from a cross-sectional TEM image that the FePt particles have a globular shape and FePt is present as a monolayer. However, when the film thickness is 6 nm, there is a problem that the influence of noise cannot be ignored due to the limitation in aspect ratio of a granular structure.

Meanwhile, when the film thickness is increased to 10 nm, the planar structure appeared to have no change. However, the cross-sectional TEM shows that the FePt particles have a bilayer structure. It is believed due to a very high tendency of having phase separation between FePt and C. It was also found from the observation of a structure of the granular thin film which resulted in having a bilayer structure, that C is present therebetween. Accordingly, when film thickness of an FePt—C or FePtAg—C granular thin film is 6 nm or more, the magnetic layer forms a bilayer structure in the thickness direction, and thus the FePt particles in the second layer are not perpendicularly orientated and the perpendicular anisotropy is impaired.

### INDUSTRIAL APPLICABILITY

The perpendicular magnetic recording medium according to the present invention is particularly preferred as a perpendicular magnetic recording disk which is mounted on a magnetic disk device such as HDD. It can be also particularly preferably used as a discrete track medium (DTM) or a bit patterned medium (BPM) which is highly expected to be used as a medium for achieving ultra-high density higher than the information recording density of a currently available perpendicular magnetic recording medium, or as medium for a heat assisted magnetic recording which can achieve ultra-high density higher than the information recording density of a perpendicular magnetic recording medium.

### REFERENCE SIGNS LIST

10 Substrate

20 Heat absorbing layer

30 Orientation control layer

40, 50 Magnetic layer

401, 403 First magnetic layer

402, 404 Second magnetic layer

501, 504 First magnetic layer

502, 505 Second magnetic layer

503, 506 Third magnetic layer

1-13. (canceled)

14. A perpendicular magnetic recording medium comprising at least a magnetic layer comprising a material comprising FePt alloy as a main component on a substrate,
wherein the magnetic layer is an FePtAg—C or FePt—C granular thin film obtained by laminating a unit in multiple stages, the unit being a laminate film obtained by forming, on of an FePtAg—C layer or an FePt—C layer, at least one layer of (A) FePtAg layer or FePt layer or (B) FePtAg—C layer or FePt—C layer which has carbon concentration different from the above FePtAg—C layer or FePt—C layer.

15. The perpendicular magnetic recording medium according to claim 14, wherein the magnetic layer is the FePtAg—C or FePt—C granular thin film obtained by laminating the unit in multiple stages, the unit being the laminate film obtained by forming, on the FePtAg—C layer or the FePt—C layer, the FePtAg layer or the FePt layer.

16. The perpendicular magnetic recording medium according to claim 14, wherein the magnetic layer is the FePtAg—C or FePt—C granular thin film obtained by laminating the unit in multiple stages, the unit being the laminate film obtained by laminating at least two layers of the FePtAg—C layer or the FePt—C layer in which carbon concentration increases gradually from the substrate side.

17. The perpendicular magnetic recording medium according to claim 14, wherein film thickness of each layer constituting the magnetic layer is 0.1 nm or more and less than 6 nm.

18. The perpendicular magnetic recording medium according to claim 14, wherein it has, on the substrate, at least a heat absorbing layer with high heat conductivity, a crystalline orientation control layer, and the magnetic layer in the order.

19. The perpendicular magnetic recording medium according to claim 14, wherein the orientation control layer has a lattice constant mismatch of 10% or less with FePt (001) of L1₀ structure.

20. The perpendicular magnetic recording medium according to claim 14, wherein the magnetic layer is a ferromagnetic layer of granular structure which has crystal particles having FePt alloy with L1₀ structure as a main component and a grain boundary part having non-magnetic substance C as a main component.

21. The perpendicular magnetic recording medium according to claim 14, further comprising, between the substrate and the orientation control layer, a soft magnetic layer in addition to the heat absorbing layer.

22. A method for producing a perpendicular magnetic recording medium having a magnetic layer which comprises at least FePt alloy as a main component on a substrate, wherein a film of an FePtAg—C layer or an FePt—C layer is formed by sputtering, on the substrate at substrate temperature of 600° C. or lower, at least one layer of (A) FePtAg layer or FePt layer or (B) FePtAg—C layer or FePt—C layer which has carbon concentration different from the above FePtAg—C layer or FePt—C layer is formed on the FePtAg—C layer or FePt—C layer by sputtering to give a laminate film as one unit, and the unit is laminated in multiple stages to form an FePtAg—C or FePt—C granular thin film.

23. The method for producing a perpendicular magnetic recording medium according to claim 22, wherein the film of FePtAg—C layer or the FePt—C layer is formed by sputtering on the substrate at substrate temperature of 600° C. or lower, the film of FePtAg layer or the FePt layer is formed on the above FePtAg—C layer or FePt—C layer by sputtering to give the laminate film as one unit, and the unit is laminated in multiple stages to form the FePtAg—C or FePt—C granular thin film.

24. The method for producing a perpendicular magnetic recording medium according to claim 22, wherein at least two layers of the FePtAg—C layer or the FePt—C layer having gradually increasing carbon concentration from the substrate side are formed by sputtering on the substrate at substrate temperature of 600° C. or lower to give the laminate film as one unit, and the unit is laminated in multiple stages to form the FePtAg—C or FePt—C granular thin film.

25. The method for producing a perpendicular magnetic recording medium according to claim 22, wherein film thickness of each layer constituting the magnetic layer is 0.1 nm or more and less than 6 nm.

26. The method for producing a perpendicular magnetic recording medium according to claim 22, wherein an annealing treatment is performed at temperature of 600° C. or lower after the film forming.
